(19) United States
(12) Patent Application Publication
(10) Pub. No.: US 2008/0075165 A1
(43) Pub. Date: Mar. 27, 2008

(54) Adaptive interpolation filters for video coding

(75) Inventors: Kemal Ugur, Tampere (FI); Jani Lainema, Tampere, IL (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/904,315

(22) Filed: Sep. 25, 2007

Related U.S. Application Data
(60) Provisional application No. 60/847,566, filed on Sep. 26, 2006.

(51) Int. Cl. H04N 11/02

(52) U.S. Cl. 375/240.12; 375/240.01; 375/E07.076; 375/E07.243

(57) ABSTRACT

In encoding or decoding a video sequence having a sequence of video frames, interpolation filter coefficients for each frame or macroblock are adapted so that the non-stationary properties of the video signal are captured more accurately. A filter-type selection block in the encoder is used to determine the filter-type for use in the adaptive interpolation filter (AIF) scheme by analyzing the input video signal. Filter-type information is transmitted along with filter coefficients to the decoder. This information specifies, from a pre-defined set of filter types, what kind of interpolation filter is used. The number of filter coefficients that is sent depends on the filter-type. This number is pre-defined for each filter-type. Based on the filter-type and the filter coefficients, a filter constructing block in the decoder constructs the interpolation filter

This patent application is based on and claims priority to a co-pending U.S. Patent Application No. 60/847,866, filed Sep. 26, 2006.

### FIELD OF THE INVENTION

The present invention is related to video coding and, more particularly, to motion compensated prediction in video compression.

### BACKGROUND OF THE INVENTION

Motion Compensated Prediction (MCP) is a technique used by many video compression standards to reduce the size of the encoded bitstream. In MCP, a prediction for the current frame is formed based on one or more previous frames, and only the difference between the original video signal and the prediction signal is encoded and sent to the decoder. The prediction signal is formed by first dividing the frame into blocks and searching a best match in the reference frame for each block. The motion of the block relative to reference frame is thus determined and the motion information is coded into the bitstream as motion vectors (MV). By decoding the motion vector data embedded in the bitstream, a decoder is able to reconstruct the exact prediction.

The motion vectors do not necessarily have full-pixel accuracy but could have fractional pixel accuracy as well. This means that, motion vectors can also point to fractional pixel locations of the reference image. In order to obtain the samples at fractional pixel locations, interpolation filters are used in the MCP process. Current video coding standards describe how the decoder should obtain the samples at fractional pixel accuracy by defining an interpolation filter. In some standards, motion vectors can have at most half pixel accuracy and the samples at half pixel locations are obtained by averaging the neighboring samples at full-pixel locations. Other standards support motion vectors with up to quarter pixel accuracy where half pixel samples are obtained by symmetric-separable 6-tap filter and quarter pixel samples are obtained by averaging the nearest half or full pixel samples.

### SUMMARY OF THE INVENTION

In order to improve the coding efficiency of a video coding system, the interpolation filter coefficients for each frame or macroblock are adapted so that the non-stationary properties of the video signal are captured more accurately.

According to one embodiment of the present invention, a filter-type selection block in the encoder is used to determine the filter-type for use in the adaptive interpolation filter (AIF) scheme by analyzing the input video signal. Filter-type information is transmitted along with filter coefficients to the decoder. This information specifies, from a pre-defined set of filter types, what kind of interpolation filter is used. The number of filter coefficients that is sent depends on the filter-type. This number is pre-defined for each filter-type. Based on the filter-type and the filter coefficients, a filter constructing block in the decoder constructs the interpolation filter.

Thus, the first aspect of the present invention is a method for encoding, which comprises:

selecting a filter-type based on symmetry properties of encoding images in a digital video sequence for providing a selected filter-type, wherein the digital video sequence comprises a sequence of video frame;

calculating coefficient values of an interpolation filter based on the selected filter-type and a prediction signal representative of a difference between a video frame and a reference image; and

providing the coefficient values and the selected filter-type in an encoded video data.

According to the present invention, the prediction signal is calculated from the reference image based on a predefined base filter and motion estimation performed on the video frame. The predefined base filter has fixed coefficient values.

According to the present invention, each video frame has a plurality of pixel values, and the coefficient values are selected from interpolation of pixel values in a selected image segment in the video frame.

According to the present invention, symmetry properties of the images comprise a vertical symmetry, a horizontal symmetry and a combination thereof.

According to the present invention, the interpolation filter is symmetrical according to the selected filter type such that only a portion of the coefficient values are coded.

The second aspect of the present invention is an apparatus for encoding, which comprises:

a selection module for selecting a filter-type based on symmetrical properties of images in a digital video sequence having a sequence of video frame for providing a selected filter-type;

a computation module for calculating coefficient values of an interpolation filter based on the selected filter-type and a prediction signal representative of a difference between a video frame and a reference image; and

a multiplexing module for providing the coefficient values and the selected filter-type in an encoded video data.

According to the present invention, the prediction signal is calculated from the reference image based on a predefined base filter and motion estimation performed on the video frame. The predefined base filter has fixed coefficient values.

According to the present invention, each video frame has a plurality of pixel values, and the coefficient values are selected from interpolation of pixel values in a selected image segment in the video frame.

According to the present invention, the symmetry properties of images in the video sequence comprise a vertical symmetry, a horizontal symmetry and a combination thereof.

According to the present invention, the interpolation filter is symmetrical according to the selected filter type such that only a portion of the filter coefficients are coded.

The third aspect of the present invention is a decoding method, which comprises:

retrieving from encoded video data a set of coefficient values of an interpolation filter and a filter-type of the interpolation filter, the encoded video data indicative of a digital video sequence comprising a sequence of video frames, each frame of the video sequence comprising a plurality of pixels having pixel values;

constructing the interpolation filter based on the set of coefficient values, the filter-type and a predefined base filter; and

reconstructing the pixel values in a frame of the video sequence based on the constructed interpolation filter and the encoded video data.

According to the present invention, the predefined base filter has fixed coefficient values.

According to the present invention, wherein the filter type is selected based on symmetry properties of images in the video sequence, and the symmetry properties comprise a vertical symmetry, a horizontal symmetry and a combination thereof.

According to the present invention, the interpolation filter is symmetrical according to the selected filter type such that only a portion of the filter coefficients are coded.

The forth aspect of the present invention is a decoding apparatus, which comprises:

a demultiplexing module for retrieving from encoded video data a set of coefficient values of an interpolation filter and a filter-type of the interpolation filter, the encoded video data indicative of a digital video sequence comprising a sequence of video frames, each frame of the video sequence comprising a plurality of pixels having pixel values;

a filter construction module for constructing the interpolation filter based on the set of coefficient values, the filter-type and a predefined base filter; and

an interpolation module for reconstructing the pixel values in a frame of the video sequence based on the constructed interpolation filter and the encoded video data.

The fifth aspect of the present invention is a video coding system comprising an encoding apparatus and a decoding apparatus as described above. Alternatively, the video coding system comprises:

an encoder for encoding images in a digital video sequence having a sequence of video frames for providing encoded video data indicative of the video sequence, and

a decoder for decoding the encoded video data, wherein the encoder comprises:
means for selecting a filter-type based on symmetrical properties of the images;
means for calculating coefficient values of an interpolation filter based on the selected filter-type and a prediction signal representative of a difference between a video frame and a reference image; and
means for providing the coefficient values and the selected filter-type in the encoded video data, and wherein

the decoder comprises:
means for retrieving from the encoded video data a set of coefficient values of an interpolation filter and a filter-type of the interpolation filter;
means for constructing the interpolation filter based on the set of coefficient values, the filter-type and a predefined base filter; and
means for reconstructing the pixel values in a frame of the video sequence based on the constructed interpolation filter and the encoded video data.

The sixth aspect of the present invention is a software application product having programming codes for carrying out the encoding method as described above.

The seventh aspect of the present invention is a software application product having programming codes for carrying out the decoding method as described above.

The eighth aspect of the present invention is an electronic device, such as a mobile phone, having the video encoding system as described above.

The present invention will become apparent upon reading the descriptions taken in conjunction with FIGS. 1 to 7.

### BRIEF DESCRIPTION OF THE DRAWINGS

FIG. 1 shows the naming convention used for locations of integer and sub-pixel samples.

FIG. 2 is a table showing the details of an HOR-AIF type filter for each sub-pixel.

FIG. 3 is a table showing the details of a VER-AIF type filter for each sub-pixel.

FIG. 4 is a table showing the details of an H+V-AIF type filter for each sub-pixel.

FIG. 5 is a block diagram illustrating a video encoder according to one embodiment of the present invention.

FIG. 6a is a block diagram illustrating a video decoder according to one embodiment of the present invention.

FIG. 6b is a block diagram illustrating a video decoder according to another embodiment of the present invention.

FIG. 7 is a block diagram illustrating a terminal device comprising video encoder and decoding equipment capable of carrying out the present invention.

### DETAILED DESCRIPTION OF THE INVENTION

The operating principle of a video coder employing motion compensated prediction is to minimize the amount of information in a prediction error frame Eₙ(x,y), which is the difference between a current frame Iₙ(x,y) being coded and a prediction frame Pₙ(x,y). The prediction error frame is thus defined as follows:
Eₙ(x,y)=Iₙ(x,y)−Pₙ(x,y).
The prediction frame Pₙ(x,y) is built using pixel values of a reference frame Rₙ(x,y), which is generally one of the previously coded and transmitted frames, for example, the frame immediately preceding the current frame. The reference frame Rₙ(x,y) is available from the frame memory block of an encoder. More specifically, the prediction frame Pₙ(x,y) can be constructed by finding “prediction pixels” in the reference frame Rₙ(x,y), corresponding substantially with pixels in the current frame. Motion information that describes the relationship (e.g. relative location, rotation, scale etc.) between pixels in the current frame and their corresponding prediction pixels in the reference frame is derived and the prediction frame is constructed by moving the prediction pixels according to the motion information. In this way, the prediction frame is constructed as an approximate representation of the current frame, using pixel values in the reference frame. Thus, the prediction error frame referred to above represents the difference between the approximate representation of the current frame provided by the prediction frame and the current frame itself. The basic advantage provided by video encoders that use motion compensated prediction arises from the fact that a comparatively compact description of the current frame can be obtained by the motion information required to form its prediction, together with the associated prediction error information in the prediction error frame.

Due to the large number of pixels in a frame, it is generally not efficient to transmit separate motion information for each pixel to the decoder. Instead, in most video coding schemes, the current frame is divided into larger image segments Sₖ, and motion information relating to the segments is transmitted to the decoder. For example, motion information is typically provided for each macroblock of a frame and the same motion information is then used for all pixels within the macroblock. In some video coding standards, a macroblock can be divided into smaller blocks, each smaller block being provided with its own motion information.

The motion information usually takes the form of motion vectors [Δx(x,y), Δy(x,y)]. The pair of numbers Δx(x,y) and Δy(x,y) represents the horizontal and vertical displacements of a pixel (x,y) in the current frame Iₙ(x,y) with respect to a pixel in the reference frame Rₙ(x,y). The motion vectors [Δx(x,y), Δy(x,y)] are calculated in the motion field estimation block and the set of motion vectors of the current frame [Δx(•), Δy(•)] is referred to as the motion vector field.

Typically, the location of a macroblock in a current video frame is specified by the (x,y) coordinate of its upper left-hand corner. Thus, in a video coding scheme in which motion information is associated with each macroblock of a frame, each motion vector describes the horizontal and vertical displacement Δx(x,y) and Δy(x,y) of a pixel representing the upper left-hand corner of a macroblock in the current frame Iₙ(x,y) with respect to a pixel in the upper left-hand corner of a substantially corresponding block of prediction pixels in the reference frame Rₙ(x,y).

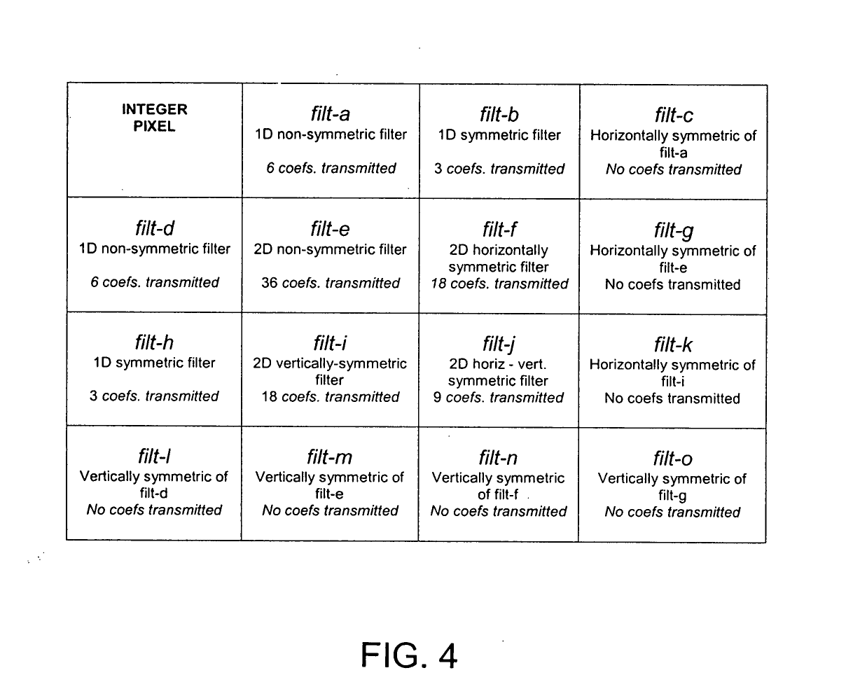

Motion estimation is a computationally intensive task. Given a reference frame Rₙ(x,y) and, for example, a square macroblock comprising N×N pixels in a current frame (as shown in FIG. 4a), the objective of motion estimation is to find an N×N pixel block in the reference frame that matches the characteristics of the macroblock in the current picture according to some criterion. This criterion can be, for example, a sum of absolute differences (SAD) between the pixels of the macroblock in the current frame and the block of pixels in the reference frame with which it is compared. This process is known generally as “block matching”. It should be noted that, in general, the geometry of the block to be matched and that in the reference frame do not have to be the same, as real-world objects can undergo scale changes, as well as rotation and warping.

In order to improve the prediction performance in video coding, it is generally desirable to transmit a large number of coefficients to the decoder. If quarter-pixel motion vector accuracy is assumed, as many as 15 independent filters should be signaled to the decoder. This means that a large number of bits are required in filter signaling. When the statistical characteristic of each image is symmetric, the number of coefficients can be reduced. However, in many video sequences, some images do not possess symmetrical properties. For example, in a video sequence where the camera is panning horizontally resulting in a horizontal motion blur, the images may possess vertical symmetry, but not horizontal symmetry. In a complex scene where different parts in the image are moving at different directions, the images may not have any horizontal or vertical symmetry.

The present invention uses at least four different symmetrical properties to construct different filters. These filters are referred to as adaptive interpolation filters (AIFs). The different symmetrical properties can be denoted as ALL-AIF, HOR-AIF, VER-AIF and H+V-AIF. After constructing these filters with different symmetrical properties, the symmetrical characteristic of each filter is adapted at each frame. As such, not only the filter coefficients are adapted, but the symmetrical characteristic of the filter is also adapted at each frame.

The present invention can be implemented as follows: First, the encoder performs the regular motion estimation for the frame using a base filter and calculates the prediction signal for the whole frame. The coefficients of the interpolation filter are calculated by minimizing the energy of the prediction signal. The reference picture or image is then interpolated using the calculated interpolation filter and motion estimation is performed using the newly constructed reference image.

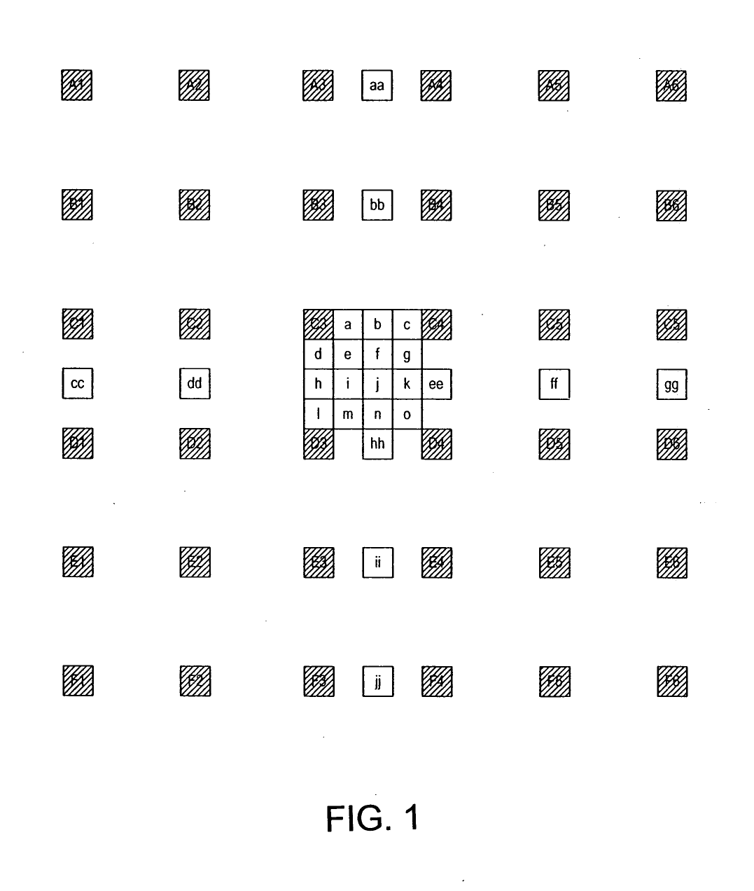

Assume 6-tap filters are used for interpolating pixel locations with quarter-pixel accuracy. The naming convention for locations of integer and sub-pixel samples are shown in FIG. 1. As shown in FIG. 1, integer samples are shown in shaded blocks with upper case letters and fractional samples are in white blocks with lower case letters. In particular, An, Bn, Cn, Dn, En and Fn (with n=1 to 6) are integer pixel samples surrounding the current pixel to be interpolated. The lower case letters a, b, c, d, e, f, g, h, i, j, k, l, m, n and o denote sub-pixel samples to be interpolated. Among those sub-pixel samples, locations b, h, j are half-pixel samples and all others are quarter-pixel samples. It is possible to use an independent filter for each sub-pixel location to interpolate the corresponding sub-pixel samples. For the locations a, b, c, d, h and l, a 1D filter with 6-taps can be used. For other locations, a 6×6 2D filter can be used. This approach results in transmitting 360 filter coefficients and may result in a high additional bitrate which could reduce the benefit of using an adaptive interpolation filter. If it is assumed that the statistical properties of an image signal are symmetric, then the same filter coefficients can be used in the case where the distance of the corresponding full-pixel positions to the current sub-pixel position is equal. In this way, some of the sub-pixel locations can use the same filter coefficients as other locations. Thus, there is no need to transmit the filter coefficients for them. For example, the filter used for interpolating h will be the same as the filter used for interpolating b. Also, the number of filter coefficients used for some sub-pixel locations can also be reduced. For example, the number of filter coefficients required for interpolating location b is reduced from 6 to 3.

Let h_{C1}^{a} be the filter coefficient used to compute the interpolated pixel at sub-pixel position a from the integer position C1, and h_{C1}^{b} be the coefficient used to compute b from the integer location C1. According to the symmetry assumption as described above, only one filter with 6 coefficients are used for the sub-pixel positions a, c, d and l, as shown below:
h_{C1}^{a}=h_{A3}^{d}=h_{C6}^{c}=h_{F3}^{l}
h_{C3}^{a}=h_{C3}^{d}=h_{C4}^{c}=h_{D3}^{l}
h_{C5}^{a}=h_{E3}^{d}=h_{C2}^{c}=h_{B3}^{l}
h_{C2}^{a}=h_{B3}^{d}=h_{C5}^{c}=h_{E3}^{l}
h_{C4}^{a}=h_{D3}^{d}=h_{C3}^{c}=h_{C3}^{l}
h_{C6}^{a}=h_{F3}^{d}=h_{C1}^{c}=h_{A3}^{l}

As such, only the following coefficients will be transmitted:
6 coefficients in total for the interpolation filter for sub-pixel locations a, c, d, l
3 coefficients in total for the interpolation filter for sub-pixel locations b, h
21 coefficients in total for the interpolation filter for sub-pixel locations e, g, m, o
18 coefficients in total for the interpolation filter for sub-pixel locations f, i, k, n
6 coefficients for the interpolation filter for sub-pixel location j

Thus, instead of transmitting 360 coefficients, only 54 coefficients are transmitted.

However, a video sequence occasionally contains images that only possess symmetry in one direction or they do not possess horizontal or vertical symmetry. It would be desirable to include other filter-types such as ALL-AIF, HOR-AIF, VER-AIF and H+V-AIF so that the non-symmetrical statistical properties of certain images can be captured more accurately.

ALL-AIF

In this filter type, a set of 6×6 independent non-symmetrical filter coefficients are sent for each sub-pixel. This means that 36 coefficients for each sub-pixel are transmitted, resulting in transmitting 540 coefficients. This filter type spends the most number of bits for coefficients.

HOR-AIF

With this filter type, it is assumed that the statistical properties of input signal are only horizontally symmetric, but not vertically symmetric. Thus, the same filter coefficients are used only if the horizontal distance of the corresponding full-pixel positions to the current sub-pixel position is equal. In addition, similar to the KTA-AIF filter type (KTA conference model), a 1D filter is used for locations a, b, c, d, h, l. The use of HOR-AIF filter type results in transmitting:
6 coefficients in total for the interpolation filter for sub-pixel locations a, c
3 coefficients for the interpolation filter for sub-pixel location b
6 coefficients for the interpolation filter for sub-pixel location d
36 coefficients in total for the interpolation filter for sub-pixel locations e, g
18 coefficients for the interpolation filter for sub-pixel location f
6 coefficients for the interpolation filter for sub-pixel location h
36 coefficients in total for the interpolation filter for sub-pixel location i, k
18 coefficients for the interpolation filter for sub-pixel location j
6 coefficients for the interpolation filter for sub-pixel location l
36 coefficients in total for the interpolation filter for sub-pixel locations m, o
18 coefficients for the interpolation filter for sub-pixel location n.

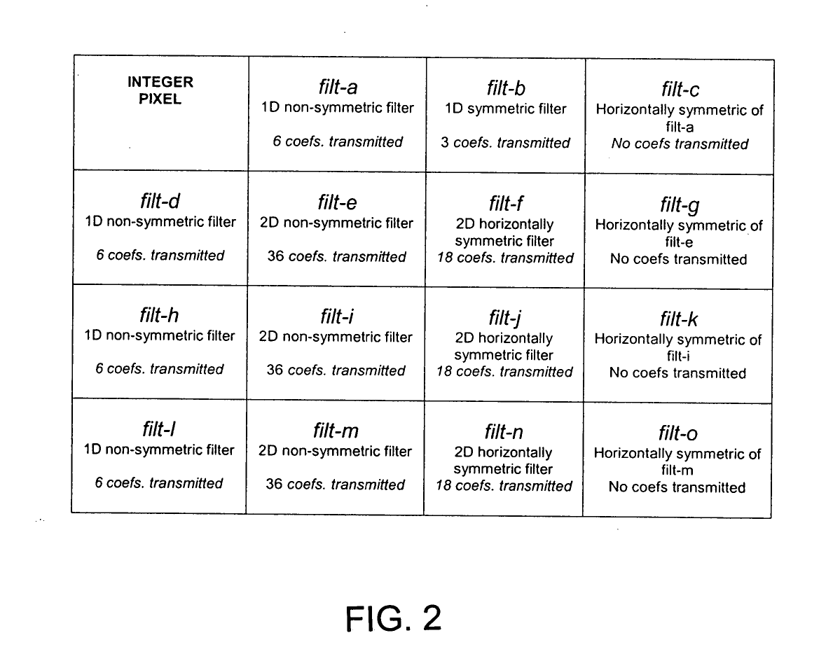

In total, 189 coefficients are sent for the HOR-AIF type filter. The details of the HOR-AIF type filter for each sub-pixel are shown in FIG. 2.

VER-AIF

This filter type is similar to HOR-AIF, but it is assumed that the statistical properties of input signal are only vertically symmetric. Thus, the same filter coefficients are used only if the vertical distance of the corresponding full-pixel positions to the current sub-pixel position is equal. The use of VER-AIF type filter results in transmitting:
6 coefficients for the interpolation filter for sub-pixel location a
6 coefficients for the interpolation filter for sub-pixel location b
6 coefficients for the interpolation filter for sub-pixel location c
6 coefficients in total for the interpolation filter for sub-pixel locations d, l
36 coefficients in total for the interpolation filter for sub-pixel location e, m
36 coefficients in total for the interpolation filter for sub-pixel locations f, n
36 coefficients in total for the interpolation filter for sub-pixel locations g, o
3 coefficients for the interpolation filter for sub-pixel location h
18 coefficients for the interpolation filter for sub-pixel location i
18 coefficients for the interpolation filter for sub-pixel location j
18 coefficients for the interpolation filter for sub-pixel location k

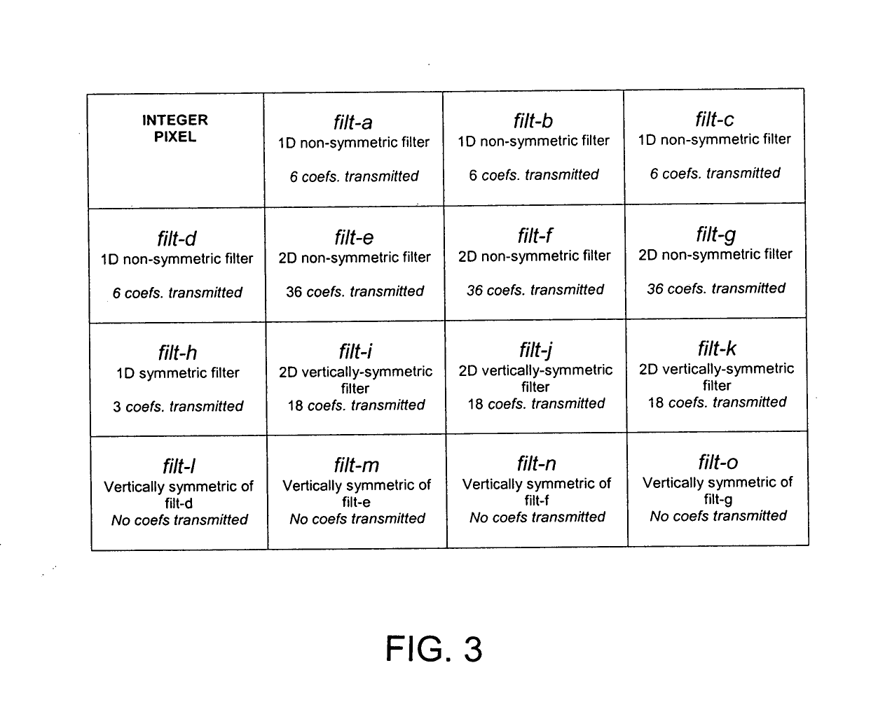

In total, 189 coefficients are sent for the VER-AIF type filter. The details of the VER-AIF type filter for each sub-pixel are shown in FIG. 3.

H+V-AIF

With this filter type, it is assumed that the statistical properties of input signal are both horizontally and vertically symmetric. Thus, the same filter coefficients are used only if the horizontal or vertical distance of the corresponding full-pixel positions to the current sub-pel position is equal. In addition, similar to KTA-AIF, a 1D filter is used for the sub-pixel locations a,b,c,d,h,l. The use of the H+V-AIF filter type results in transmitting:
6 coefficients in total for the interpolation filter for sub-pixel locations a, c
3 coefficients for the interpolation filter for sub-pixel location b
6 coefficients in total for the interpolation filter for sub-pixel locations d, l
36 coefficients in total for the interpolation filter for sub-pixel locations e, g, m, o
18 coefficients for the interpolation filter for sub-pixel locations f, n
3 coefficients for the interpolation filter for sub-pixel location h
18 coefficients in total for the interpolation filter for sub-pixel locations i, k
9 coefficients for the interpolation filter for sub-pixel location j.

In total 99 coefficients are sent for the H+V-AIF type filter. The details of the H+V-AIF type filter for each sub-pixel are shown in FIG. 4.

In one embodiment of the present invention, motion estimation is performed first using the standard interpolation filter (e.g. AVC or Advanced Video Coding interpolation filter) and a prediction signal is generated. Using the prediction signal, filter coefficients are calculated for each filter type. Then, motion estimation, transform and quantization are performed for each filter type. The filter type resulting in the least number of bits for the luminance component of the image is chosen. This algorithm presents a practical upper bound for the above-described scheme.

The present invention can be implemented in many different ways. For example:
The number of filter types can vary.
The filters can be defined in different ways with respect to their symmetrical properties, for example.
The filters can have different numbers of coefficients.
The 2D filters can be separable or non-separable.
The filter coefficients can be coded in various ways.
The encoder can utilize different algorithms to find the filter coefficients

In signaling the symmetrical properties for each sub-pixel location independently, it is possible that the encoder signals the symmetrical characteristic of the filter once before sending the filter coefficients for all sub-pixel locations. A possible syntax for signaling is as follows:

adaptive_interpolation_filter( ) {

filter_type

For each subpixel location {

| | |
|---|---|
| filter_coefficients( ) | Number of |

coefficients sent here depends on the
filter_type

}

}

It is also possible to include a syntax such as

adaptive_interpolation_filter( ) {
For each subpixel location {

| Filter_type | |
|---|---|
| Filter_coefficients( ) | Number of |

coefficients sent here depends on the
filter_type

}

}

In order to carry out the present invention, the method and system of video coding involves the following:

i) A filter_type selecting block at the encoder that decides on the filter type that the AIF scheme uses by analyzing the input video signal.

ii) Transmitting filter_type information along with filter coefficients to the decoder. filter_type specifies what kind of interpolation filter is used from a pre-defined set of filter types. The number of filter coefficients that is sent depends on the filter_type and is pre-defined for each filter_type.

iii) A set of different pre-defined filter types with different symmetrical properties that could capture the non-symmetrical statistical properties of certain input images more accurately.

iv) A filter constructing block in the decoder that uses both the filter_type and the filter coefficients information to construct the interpolation filter.

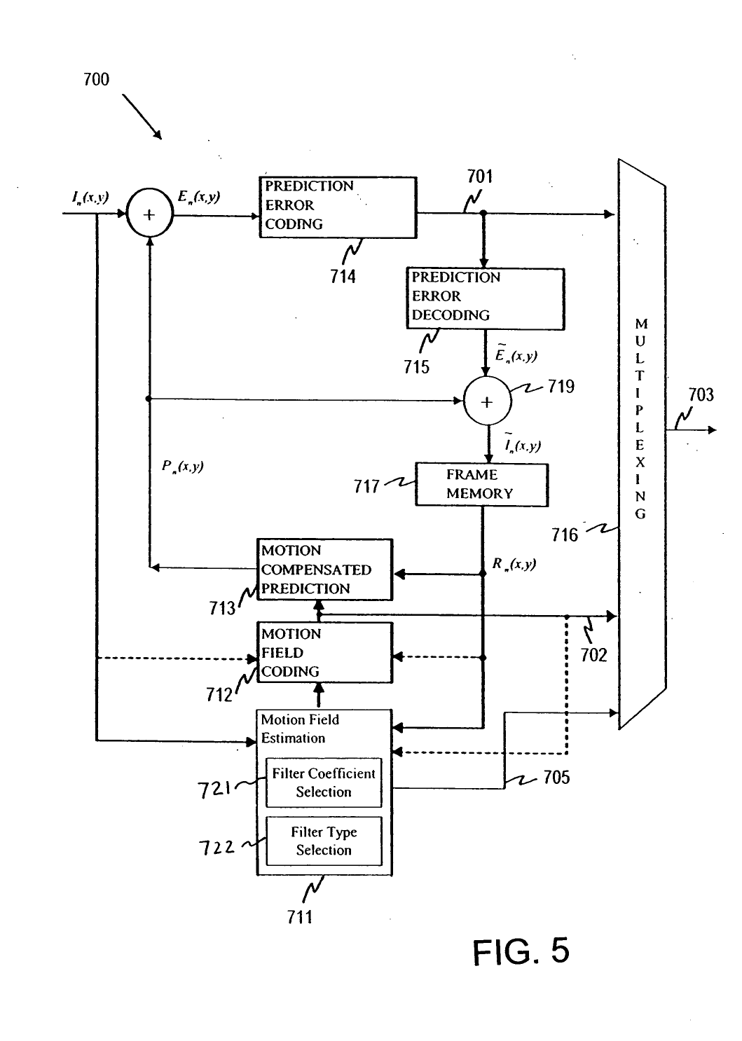

FIG. 5 is a schematic block diagram of a video encoder 700 implemented according to an embodiment of the invention. In particular video encoder 700 comprises a Motion Field Estimation block 711, a Motion Field Coding block 712, a Motion Compensated Prediction block 713, a Prediction Error Coding block 714, a Prediction Error Decoding block 715, a Multiplexing block 716, a Frame Memory 717, and an adder 719. As shown in FIG. 5, the Motion Field Estimation block 711 also includes a Filter Coefficient Selection block 721 and a Filter Type Selection block 722, which is used to select a filter-type from a set of five filter-types: the symmetrical filter that is associated with 56 coefficients, ALL-AIF, HOR-AIG, VER-AIF and H+V-AIF. The different filter types will have different symmetrical properties and a different number of coefficients associated with the filters.

Operation of the video encoder 700 will now be considered in detail. As with a prior art video encoder, the video encoder 700, according to one embodiment of the present invention, employs motion compensated prediction with respect to a reference frame Rₙ(x,y) to produce a bit-stream representative of a video frame being coded in INTER format. The encoder performs motion compensated prediction to sub-pixel resolution and further employs an interpolation filter having dynamically variable filter coefficient values in order to form the sub-pixel values required during the motion estimation process.

Video encoder 700 performs motion compensated prediction on a block-by-block basis and implements motion compensation to sub-pixel resolution as a two-stage process for each block.

In the first stage, a motion vector having full-pixel resolution is determined by block-matching, i.e., searching for a block of pixel values in the reference frame Rₙ(x,y) that matches best with the pixel values of the current image block to be coded. The block matching operation is performed by Motion Field Estimation block 711 in co-operation with Frame Store 717, from which pixel values of the reference frame Rₙ(x,y) are retrieved.

In the second stage of motion compensated prediction, the motion vector determined in the first stage is refined to the desired sub-pixel resolution. To do this, Motion Field Estimation block 711 forms new search blocks having sub-pixel resolution by interpolating the pixel values of the reference frame Rₙ(x,y) in the region previously identified as the best match for the image block currently being coded (see FIG. 5). As part of this process, Motion Field Estimation block 711 determines an optimum interpolation filter for interpolating the sub-pixel values. The coefficient values of the interpolation filter can be adapted in connection with the encoding of each image block. In alternative embodiments, the coefficients of the interpolation filter may be adapted less frequently, for example once every frame, or at the beginning of a new video sequence to be coded.

Having interpolated the necessary sub-pixel values and formed new search blocks, Motion Field Estimation block 711 performs a further search in order to determine whether any of the new search blocks represent a better match to the current image block than the best matching block originally identified at full-pixel resolution. In this way, Motion Field Estimation block 711 determines whether the motion vector representative of the image block currently being coded should point to a full-pixel or sub-pixel location.

Motion Field Estimation block 711 outputs the identified motion vector to Motion Field Coding block 712, which approximates the motion vector using a motion model, as previously described. Motion Compensated Prediction block 713 then forms a prediction for the current image block using the approximated motion vector and prediction error information. The prediction is and subsequently coded in Prediction Error Coding block 714. The coded prediction error information for the current image block is then forwarded from Prediction Error Coding block 714 to Multiplexer block 716. Multiplexer block 716 also receives information about the approximated motion vector (in the form of motion coefficients) from Motion Field Coding block 712, as well as information about the optimum interpolation filter used during motion compensated prediction of the current image block from Motion Field Estimation Block 711. According to this embodiment of the present invention, Motion Field Estimation Block 711, based on the computational result computed by the differential coefficient computation block 710, transmits a set of difference values 705 indicative of the difference between the filter coefficients of the optimum interpolation filter for the current block and the coefficients of a predefined base filter 709 stored in the encoder 700. Multiplexer block 716 subsequently forms an encoded bit-stream 703 representative of the image current block by combining the motion information (motion coefficients), prediction error data, filter coefficient difference values and possible control information. Each of the different types of information may be encoded with an entropy coder prior to inclusion in the bit-stream and subsequent transmission to a corresponding decoder.

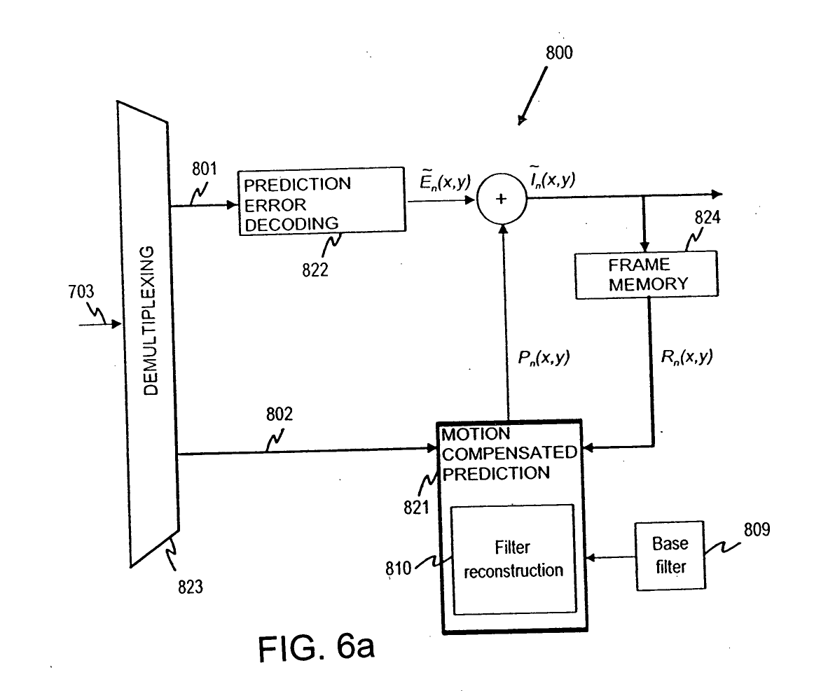

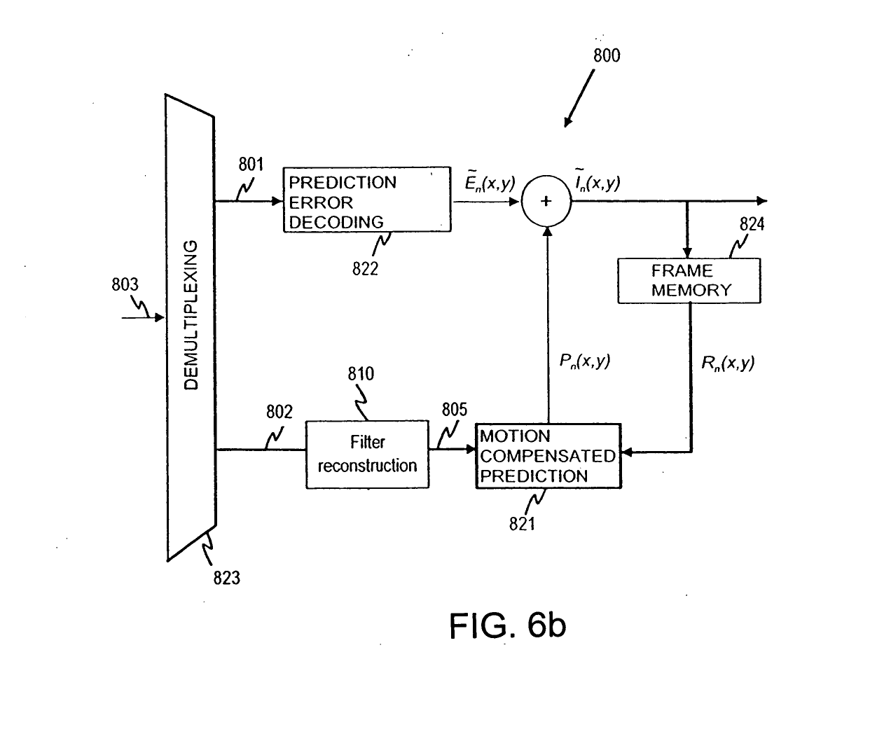

FIG. 6a is a block diagram of a video decoder 800 implemented according to an embodiment of the present invention and corresponding to the video encoder 700 illustrated in FIG. 5. The decoder 800 comprises a Motion Compensated Prediction block 821, a Prediction Error Decoding block 822, a Demultiplexing block 823 and a Frame Memory 824. The decoder 800, as shown in FIG. 6a, includes a Filter Reconstruction block 810 which reconstructs the optimum interpolation filter based on the filter_type and the filter coefficients information in order to construct the interpolation filter from the frame.

Operation of the video decoder 800 is described in the following. Demultiplexer 823 receives an encoded bit-stream 803, splits the bit-stream into its constituent parts (motion coefficients, prediction error data, filter coefficient difference values and possible control information) and performs necessary entropy decoding of the various data types. Demultiplexer 823 forwards prediction error information retrieved from the received bit-stream 803 to Prediction Error Decoding block 822. It also forwards the received motion information to Motion Compensated Prediction block 821. In this embodiment of the present invention, Demultiplexer 823 forwards the received (and entropy decoded) difference values via signal 802 to Motion Compensated Prediction block 821. As such, Filter Reconstruction block 810 is able to reconstruct the optimum interpolation filter by adding the received difference values to the coefficients of a predefined base filter 809 stored in the decoder. Motion Compensated Prediction block 821 subsequently uses the optimum interpolation filter as defined by the reconstructed coefficient values to construct a prediction for the image block currently being decoded. More specifically, Motion Compensated Prediction block 821 forms a prediction for the current image block by retrieving pixel values of a reference frame Rₙ(x,y) stored in Frame Memory 824 and interpolating them as necessary according to the received motion information to form any required sub-pixel values. The prediction for the current image block is then combined with the corresponding prediction error data to form a reconstruction of the image block in question.

Alternatively, Filter Reconstruction block 810 resides outside of Motion Compensated Prediction block 821, as shown in FIG. 6b. From the difference values contained in signal 802 received from Demultiplexer 823, Filter Reconstruction block 810 reconstructs the optimum interpolation filters and sends the reconstruct filter coefficients 805 to Motion Compensated Prediction block 821.

In yet another alternative embodiment, Filter Reconstruction block 810 resides within Demultiplexer block 823. Demultiplexer block 823 forwards the reconstructed coefficients of the optimum interpolation filter to Motion Compensated Prediction Block 821.

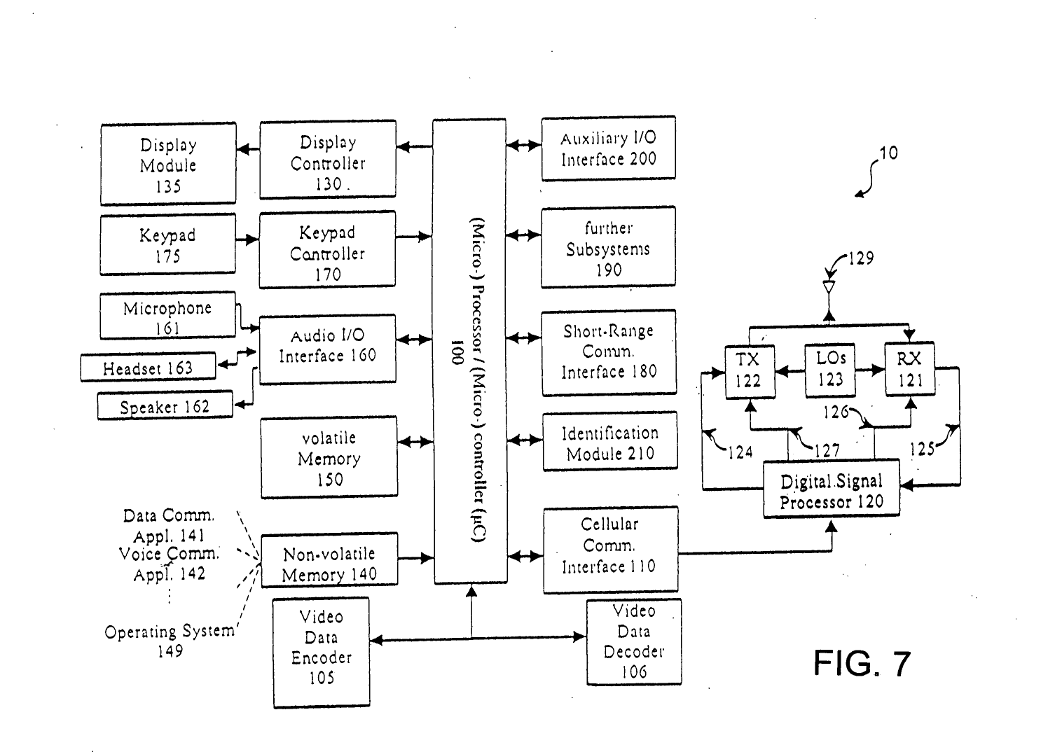

Referring now to FIG. 7. FIG. 7 shows an electronic device that equips at least one of the motion compensated temporal filtering (MCTF) encoding module and the MCTF decoding module as shown in FIGS. 9 and 10. According to one embodiment of the present invention, the electronic device is a mobile terminal. The mobile device 10 shown in FIG. 7 is capable of cellular data and voice communications. The mobile device 10 includes a (main) microprocessor or micro-controller 100 as well as components associated with the microprocessor controlling the operation of the mobile device. These components include a display controller 130 connecting to a display module 135, a non-volatile memory 140, a volatile memory 150 such as a random access memory (RAM), an audio input/output (I/O) interface 160 connecting to a microphone 161, a speaker 162 and/or a headset 163, a keypad controller 170 connected to a keypad 175 or keyboard, any auxiliary input/output (I/O) interface 200, and a short-range communications interface 180. Such a device also typically includes other device subsystems shown generally as block 190.

The mobile device 10 may communicate over a voice network and/or may likewise communicate over a data network, such as any public land mobile networks (PLMNs) in the form of e.g. digital cellular networks, especially GSM (global system for mobile communication) or UMTS (universal mobile telecommunications system). Typically the voice and/or data communication is operated via an air interface, i.e. a cellular communication interface subsystem in cooperation with further components (see above) to a base station (BS) or node B (not shown) being part of a radio access network (RAN) of the infrastructure of the cellular network.

The cellular communication interface subsystem as depicted illustratively in FIG. 7 comprises the cellular interface 110, a digital signal processor (DSP) 120, a receiver (RX) 121, a transmitter (TX) 122, and one or more local oscillators (LOs) 123 and enables the communication with one or more public land mobile networks (PLMNs). The digital signal processor (DSP) 120 sends communication signals 124 to the transmitter (TX) 122 and receives communication signals 125 from the receiver (RX) 121. In addition to processing communication signals, the digital signal processor 120 also provides for the receiver control signals 126 and transmitter control signal 127. For example, besides the modulation and demodulation of the signals to be transmitted and signals received, respectively, the gain levels applied to communication signals in the receiver (RX) 121 and transmitter (TX) 122 may be adaptively controlled through automatic gain control algorithms implemented in the digital signal processor (DSP) 120. Other transceiver control algorithms could also be implemented in the digital signal processor (DSP) 120 in order to provide more sophisticated control of the transceiver 121/122.

In case the mobile device 10 communications through the PLMN occur at a single frequency or a closely-spaced set of frequencies, then a single local oscillator (LO) 123 may be used in conjunction with the transmitter (TX) 122 and receiver (RX) 121. Alternatively, if different frequencies are utilized for voice/data communications or transmission versus reception, then a plurality of local oscillators can be used to generate a plurality of corresponding frequencies.

Although the mobile device 10 depicted in FIG. 7 is used with the antenna 129 or with a diversity antenna system (not shown), the mobile device 10 could be used with a single antenna structure for signal reception as well as transmission. Information, which includes both voice and data information, is communicated to and from the cellular interface 110 via a data link between the digital signal processor (DSP) 120. The detailed design of the cellular interface 110, such as frequency band, component selection, power level, etc., will be dependent upon the wireless network in which the mobile device 10 is intended to operate.

After any required network registration or activation procedures, which may involve the subscriber identification module (SIM) 210 required for registration in cellular networks, have been completed, the mobile device 10 may then send and receive communication signals, including both voice and data signals, over the wireless network. Signals received by the antenna 129 from the wireless network are routed to the receiver 121, which provides for such operations as signal amplification, frequency down conversion, filtering, channel selection, and analog to digital conversion. Analog to digital conversion of a received signal allows more complex communication functions, such as digital demodulation and decoding, to be performed using the digital signal processor (DSP) 120. In a similar manner, signals to be transmitted to the network are processed, including modulation and encoding, for example, by the digital signal processor (DSP) 120 and are then provided to the transmitter 122 for digital to analog conversion, frequency up conversion, filtering, amplification, and transmission to the wireless network via the antenna 129.

The microprocessor/micro-controller (μC) 110, which may also be designated as a device platform microprocessor, manages the functions of the mobile device 10. Operating system software 149 used by the processor 110 is preferably stored in a persistent store such as the non-volatile memory 140, which may be implemented, for example, as a Flash memory, battery backed-up RAM, any other non-volatile storage technology, or any combination thereof. In addition to the operating system 149, which controls low-level functions as well as (graphical) basic user interface functions of the mobile device 10, the non-volatile memory 140 includes a plurality of high-level software application programs or modules, such as a voice communication software application 142, a data communication software application 141, an organizer module (not shown), or any other type of software module (not shown). These modules are executed by the processor 100 and provide a high-level interface between a user of the mobile device 10 and the mobile device 10. This interface typically includes a graphical component provided through the display 135 controlled by a display controller 130 and input/output components provided through a keypad 175 connected via a keypad controller 170 to the processor 100, an auxiliary input/output (I/O) interface 200, and/or a short-range (SR) communication interface 180. The auxiliary I/O interface 200 comprises especially USB (universal serial bus) interface, serial interface, MMC (multimedia card) interface and related interface technologies/standards, and any other standardized or proprietary data communication bus technology, whereas the short-range communication interface radio frequency (RF) low-power interface includes especially WLAN (wireless local area network) and Bluetooth communication technology or an IRDA (infrared data access) interface. The RF low-power interface technology referred to herein should especially be understood to include any IEEE 801.xx standard technology, which description is obtainable from the Institute of Electrical and Electronics Engineers. Moreover, the auxiliary I/O interface 200 as well as the short-range communication interface 180 may each represent one or more interfaces supporting one or more input/output interface technologies and communication interface technologies, respectively. The operating system, specific device software applications or modules, or parts thereof, may be temporarily loaded into a volatile store 150 such as a random access memory (typically implemented on the basis of DRAM (direct random access memory) technology for faster operation). Moreover, received communication signals may also be temporarily stored to volatile memory 150, before permanently writing them to a file system located in the non-volatile memory 140 or any mass storage preferably detachably connected via the auxiliary I/O interface for storing data. It should be understood that the components described above represent typical components of a traditional mobile device 10 embodied herein in the form of a cellular phone. The present invention is not limited to these specific components and their implementation is depicted merely for illustration and for the sake of completeness.

An exemplary software application module of the mobile device 10 is a personal information manager application providing PDA functionality including typically a contact manager, calendar, a task manager, and the like. Such a personal information manager is executed by the processor 100, may have access to the components of the mobile device 10, and may interact with other software application modules. For instance, interaction with the voice communication software application allows for managing phone calls, voice mails, etc., and interaction with the data communication software application enables for managing SMS (soft message service), MMS (multimedia service), e-mail communications and other data transmissions. The non-volatile memory 140 preferably provides a file system to facilitate permanent storage of data items on the device particularly including calendar entries, contacts etc. The ability for data communication with networks, e.g. via the cellular interface, the short-range communication interface, or the auxiliary I/O interface enables upload, download, and synchronization via such networks.

The application modules 141 to 149 represent device functions or software applications that are configured to be executed by the processor 100. In most known mobile devices, a single processor manages and controls the overall operation of the mobile device as well as all device functions and software applications. Such a concept is applicable for today's mobile devices. The implementation of enhanced multimedia functionalities includes, for example, reproducing of video streaming applications, manipulating of digital images, and capturing of video sequences by integrated or detachably connected digital camera functionality. The implementation may also include gaming applications with sophisticated graphics and the necessary computational power. One way to deal with the requirement for computational power, which has been pursued in the past, solves the problem for increasing computational power by implementing powerful and universal processor cores. Another approach for providing computational power is to implement two or more independent processor cores, which is a well known methodology in the art. The advantages of several independent processor cores can be immediately appreciated by those skilled in the art. Whereas a universal processor is designed for carrying out a multiplicity of different tasks without specialization to a pre-selection of distinct tasks, a multi-processor arrangement may include one or more universal processors and one or more specialized processors adapted for processing a predefined set of tasks. Nevertheless, the implementation of several processors within one device, especially a mobile device such as mobile device 10, requires traditionally a complete and sophisticated re-design of the components.

It should be noted that the present invention is not limited to this specific embodiment, which represents one of a multiplicity of different embodiments.

In the following, the present invention will provide a concept which allows simple integration of additional processor cores into an existing processing device implementation enabling the omission of expensive complete and sophisticated redesign. The inventive concept will be described with reference to system-on-a-chip (SoC) design. System-on-a-chip (SoC) is a concept of integrating at least numerous (or all) components of a processing device into a single high-integrated chip. Such a system-on-a-chip can contain digital, analog, mixed-signal, and often radio-frequency functions—all on one chip. A typical processing device comprises a number of integrated circuits that perform different tasks. These integrated circuits may include microprocessor, memory, universal asynchronous receiver-transmitters (UARTs), serial/parallel ports, direct memory access (DMA) controllers, and the like. A universal asynchronous receiver-transmitter (UART) translates between parallel bits of data and serial bits. The recent improvements in semiconductor technology cause very-large-scale integration (VLSI) integrated circuits to enable a significant growth in complexity, making it possible to integrate numerous components of a system in a single chip. With reference to FIG. 7, one or more components thereof, e.g. the controllers 130 and 170, the memory components 150 and 140, and one or more of the interfaces 200, 180 and 110, can be integrated together with the processor 100 in a single chip which forms finally a system-on-a-chip (Soc).

Additionally, the device 10 is equipped with a module for scalable encoding 105 and scalable decoding 106 of video data according to the inventive operation of the present invention. By means of the CPU 100 said modules 105, 106 may individually be used. However, the device 10 is adapted to perform video data encoding or decoding respectively. Said video data may be received by means of the communication modules of the device or it also may be stored within any imaginable storage means within the device 10. Video data can be conveyed in a bitstream between the device 10 and another electronic device in a communications network.

In sum, the present invention provides a method, a system and a software application product (typically embedded in a computer readable storage medium) for use in digital video image encoding and decoding. The method comprises selecting a filter type based on symmetrical properties of the images; calculating coefficient values of an interpolation filter based on the selected filter type; and providing the coefficient values and the selected filter-type in the encoded video data. The coefficient values are also calculated based on a prediction signal representative of the difference between a video frame and a reference image. The prediction signal is calculated from the reference image based on a predefined base filter and motion estimation performed on the video frame. The predefined base filter has fixed coefficient values. The coefficient values are selected from interpolation of pixel values in a selected image segment in the video frame. The symmetry properties of the images can be a vertical symmetry, a horizontal symmetry and a combination thereof. The interpolation filter is symmetrical according to the selected filter type such that only a portion of the filter coefficients are coded.

In decoding, the process involves retrieving from the encoded video data a set of coefficient values of an interpolation filter and a filter-type of the interpolation filter; constructing the interpolation filter based on the set of coefficient values, the filter-type and a predefined base filter; and reconstructing the pixel values in a frame of the video sequence based on the constructed interpolation filter and the encoded video data

Although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method comprising:
selecting a filter-type based on symmetry properties of images in a digital video sequence;
calculating coefficient values of an interpolation filter based on the filter-type and prediction information indicative of a difference at least between a video frame of the digital video sequence and a reference frame; and
providing the coefficient values and the filter-type in an encoded video data.

2. The method of claim 1, wherein the prediction information is estimated from the reference frame based on a predefined base filter and motion estimation performed on the video frame.

3. The method of claim 1, wherein the video frame has a plurality of pixel values, and wherein the coefficient values are selected from interpolation of pixel values in a selected image segment in the video frame.

4. The method of claim 2, wherein the predefined base filter has fixed coefficient values.

5. The method of claim 1, wherein the symmetry properties of the images comprise one or more of a vertical symmetry, a horizontal symmetry and a combination the vertical symmetry and the horizon symmetry.

6. The method of claim 1, wherein the interpolation filter is symmetrical according to the selected filter type such that only a portion of the coefficient values are coded.

7. An apparatus comprising:
a selection module configured for selecting a filter-type based on symmetry properties of images in a digital video sequence;
a computation module configured for calculating coefficient values of an interpolation filter based on the filter-type and prediction information indicative of a difference at least between a video frame and a reference frame; and
a multiplexing module configured for providing the coefficient values and the filter-type in an encoded video data.

8. The apparatus of claim 7, wherein the prediction information is estimated from the reference image based on a predefined base filter and motion estimation performed on the video frame.

9. The apparatus of claim 7, wherein each video frame has a plurality of pixel values, and wherein the coefficient values are selected from interpolation of pixel values in a selected image segment in the video frame.

10. The apparatus of claim 8, wherein the predefined base filter has fixed coefficient values.

11. The apparatus of claim 7, wherein the symmetry properties of images in the video sequence, the symmetry properties comprising a vertical symmetry, a horizontal symmetry and a combination thereof.

12. The apparatus of claim 7, wherein the interpolation filter is symmetrical according to the selected filter type such that only some the filter coefficients are coded.

13. A method comprising:
retrieving from encoded video data a set of filter coefficient values and a filter-type, the encoded video data indicative of a digital video sequence;
constructing an interpolation filter based on the set of filter coefficient values, the filter-type and a predefined base filter; and
reconstructing pixel values of a video frame in the video sequence based on the constructed interpolation filter and the encoded video data.

14. The method of claim 13, wherein the predefined base filter has fixed coefficient values.

15. The method of claim 13, wherein the filter type is selected based on symmetry properties of images in the video sequence.

16. The method of claim 15, wherein the symmetry properties comprise one or more of a vertical symmetry, a horizontal symmetry and a combination of the vertical symmetry and the horizontal symmetry.

17. The method of claim 13, wherein the interpolation filter is symmetrical according to the selected filter type such that only a portion of the filter coefficients are coded.

18. An apparatus comprising:
a demultiplexing module configured for retrieving from encoded video data a set of filter coefficient values and a filter-type, the encoded video data indicative of a digital video sequence;
a filter construction module configured for constructing an interpolation filter based on the set of filter coefficient values, the filter-type and a predefined base filter; and
an interpolation module configured for reconstructing pixel values of a video frame in the video sequence based on the constructed interpolation filter and the encoded video data.

19. The apparatus of claim 18, wherein the predefined base filter has fixed coefficient values.

20. The apparatus of claim 18, wherein the filter type is selected based on symmetry properties of images in the video sequence.

21. The apparatus of claim 18, wherein the symmetry properties comprise a vertical symmetry, a horizontal symmetry and a combination thereof, and wherein the interpolation filter is symmetrical according to the selected filter type such that only a portion of the filter coefficients are coded.

22. A software application product embedded in a computer readable storage medium, the software application product having programming codes for carrying out the method according to claim 1.

23. A software application product embedded in a computer readable storage medium, the software application product having programming codes for carrying out the method according to claim 13.

24. A video coding system comprising:
an encoder for encoding images in a digital video sequence for providing encoded video data indicative of the video sequence, and
a decoder for decoding the encoded video data, wherein
the encoder comprises:
means for selecting a filter-type based on symmetrical properties of the images;
means for calculating coefficient values of an interpolation filter based on the filter-type and a prediction signal representative of a difference between a video frame of the digital video sequence and a reference frame; and
means for providing the coefficient values and the filter-type in the encoded video data, and wherein
the decoder comprises:
means for retrieving from the encoded video data a set of coefficient values of the interpolation filter and the selected filter-type;
means for constructing the interpolation filter based on the set of coefficient values, the selected filter-type and a predefined base filter; and
means for reconstructing the pixel values in a video frame in the video sequence based on the constructed interpolation filter and the encoded video data.

25. A mobile terminal, comprising a video coding system of claim 24.
